(19) United States
(12) Patent Application Publication
(10) Pub. No.: US 2013/0209744 A1
(43) Pub. Date: Aug. 15, 2013

(54) Composite textile and method for making same

(71) Applicant: Robert Gregory Beliveau, San Pedro, CA (US)

(72) Inventor: Robert Gregory Beliveau, San Pedro, CA (US)

(21) Appl. No.: 13/385,368

(22) Filed: Feb. 14, 2012

(51) Int. Cl. B32B 5/26; B32B 38/06; B32B 37/06; B32B 38/00; B32B 5/18; B32B 3/00

(52) U.S. Cl. 428/158; 428/318.4; 442/373; 156/222; 156/220

(57) ABSTRACT

In accordance with the present invention, a novel composite textile laminate (composite fabric) and manufacturing method for the same is provided. The composite textile is particularly suitable for outdoor apparel that protects the wearer from outdoor elements such as sunlight, wind, and cold. In a preferred embodiment, the textile consists of an outer layer of elastane having a sun protective factor, an intermediate layer of polyurethane-ester open-cell foam, and an inner lining of synthetic micro-suede material or brushed nylon that contacts the skin. The outer and inner layers are flame bonded, with the intermediate foam layer in between them. The composite textile can be embossed and the perimeter is defined and sealed by laser cutting, which act against de-lamination. The result is a composite synthetic textile with improved comfort and protection. The outer elastane surface can also be sublimated with a desired image.

### BACKGROUND OF THE INVENTION

1. Field of the Invention

The present invention generally relates to composite textile fabrics and methods of manufacture thereof. More particularly, the invention relates to composite textiles for protective-outdoor apparel and accessories.

2. Background Information

Today's society is increasingly involved in outdoor sports and recreational activities yet concerns about avoiding skin cancer and other harmful effects of the sun are also greater than ever. In particular, there is a need among outdoor enthusiasts (e.g. mountaineers, cyclists, skiers) to protect their face and body from exposure to harmful Ultraviolet light and cold, wind, and particulate matter that may cause frostbite or discomfort. This includes lifeguards, mountain bikers/climbers, skiers/snowboarders, outdoor workers, motorcyclists, and anyone else that spends time in the outdoors. Some wearable materials are made of non-breathable, closed cell foam (neoprene) material which causes the skin to sweat and causing condensation. Moreover, rigid materials restrict various activities, lack comfort and flexibility, and do not provide a good fit to the user's face. This is particularly true for materials worn on the face.

Hence, flexibility, breath-ability, comfort, and usefulness or function are often sacrificed for durability, and vice versa. In order to protect against the effects of the sun, wind, and rain, composites often comprise an intermediate layer that is resistant to these elements. However, this layer also acts to prevent water vapor or condensation from escaping from a wearer's body, which causes considerable discomfort due to the buildup of water vapor or sweat on the user's body. In cold or freezing conditions, the buildup of moisture on the body lowers the body temperature and increases the chance of frostbite or illness. For example, existing face mask materials either lack comfort, do not adequately conform to a user's nose and face, are not breathable, and/or do not offer sufficient protection from the elements without trapping moisture into the user's eye wear or overheating the face.

Thus, there is a need in the market for a versatile, breathable composite textile that can be fashioned into wearable garments and accessories that comfortably fit to a user's body or face for active outdoor purposes.

### SUMMARY

In accordance with the present invention, a novel composite textile laminate (composite fabric) and manufacturing method for the same is provided. The composite textile is particularly suitable for protective outdoor apparel that protects the wearer from outdoor elements such as sunlight, wind, and cold. In a preferred embodiment, the textile consists of an outer layer of elastane having a sun protective factor, an intermediate layer of ¼″ polyurethane-ester open-cell foam, and an inner lining of synthetic micro-suede material or brushed nylon that contacts the skin. The outer and inner layers are flame bonded to each other, with the intermediate foam layer in between them. The outer elastane surface is then embossed and the composite textile is embossed and the perimeter is defined and sealed then laser cut. The embossment and laser cutting processes both act against de-lamination of the composite layers. The result is a composite synthetic textile with improved comfort (breath-ability, flexibility, and fit) and protection from outdoor elements. The outer elastane surface can also be sublimated with a desired colored image for custom design purposes.

### BRIEF DESCRIPTION OF THE DRAWINGS

The present invention, in accordance with preferred and exemplary embodiments, together with further objects and advantages thereof, is more particularly described in the following detailed description taken in conjunction with the accompanying drawings in which:

FIG. 1 shows a cross-sectional view of the composite material of the present invention.

FIG. 2 shows a curved, cross-sectional view of the composite material of the present invention.

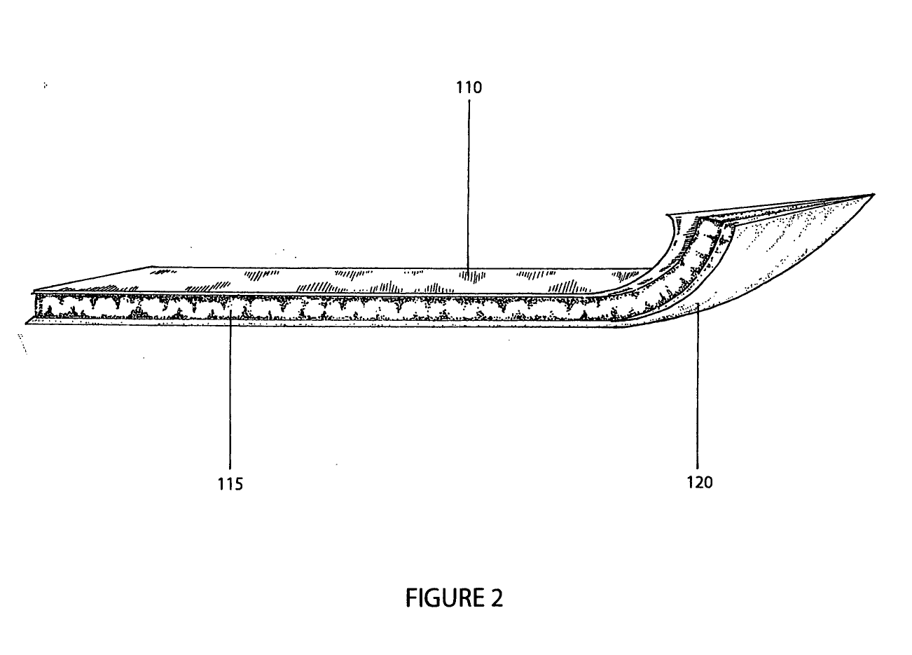

### DETAILED DESCRIPTION

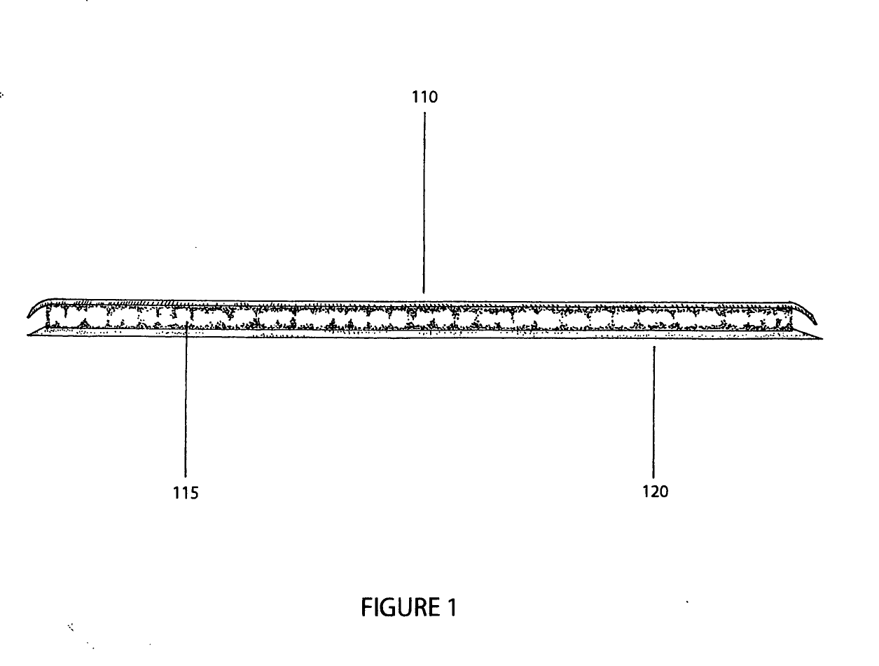

The present invention provides for a three layer composite textile having an outer, intermediate, and inner layer. Referring to FIG. 1, the outer layer 110 of the textile is a Spandex or elastane material (the terms Spandex and elastane are used interchangeably herein), preferably an 80% polyester and 20% Lycra blend. The outer layer 110 is such that it can be embossed, debossed, and/or sublimated with a desired image or print logo/design. Sublimation printing is a recent industry standard printing process that offers a variety of 4-color printing process onto a polyester fabric. The intermediate layer 115 is a polyurethane-ester open cell foam (also referred to herein as “open cell foam”). In a preferred embodiment, the open cell foam layer 115 is ⅛″ to ¼″ in thickness thick prior to being compressed and having a density of 1.6 lbs. per cubic foot. Finally, the inner layer 120 is a micro-suede, for example a 92% polyester and 8% Spandex blend. This inner layer 120 has a breathable, wicking effect that allows greater air exchange and acts against heat or moisture related discomfort when worn by a wearer. Alternatively, the inner layer 120 can be a brushed nylon or Spandex similar to the outer layer material.

The result is a foam core layer sandwiched between two synthetic fabric layers. The three layers 110, 115 and 120 are preferably joined via a thermoforming process and preferably cut via laser cutting or comparable method to provide well-sealed edges that are resistant to de-lamination. The micro-suede layer 120 can first be flame-bonded to the elastane layer 110, with the foam layer 115 sandwiched in between, followed by thermoforming. Compression plates can be used to emboss and bond the top and bottom fabrics as well as create desired pattern or design. The compression plates are then attached to a heated press, set to a temperature of approximately 400 degrees, and pressed against the layers for approximately 60 seconds of hold time at 100 pounds of pressure.

This allows the outer and inner layers to become sealed or partly welded together without melting the fabric to the plate. The sealed perimeter or borders defined by the compression plates and are then cut by a laser cutter, which not only cuts but further seals or fuses the edges of the layers together. Typically, textile composites are sewn with bias tape to incase the multiple layered perimeter or edges to keep the fabric layers from de-laminating and to provide a finished edge. However, the sealing or fusing effect provided by compression and laser cutting or die cutting eliminates the need for this additional production step, which saves time and money, while providing an edge with a more streamlined seal. After embossing of the textile or garment's internal and perimeter outline, the composite textile can be laser cut to create a desired surface as well as a finished edge. The combination of embossing and laser cutting eliminates the need for sewing the layers. The result is a light, flexible, and durable textile material with advantageous properties for use as a wearable garment material. In addition, due to its composition and density, the textile material of the present invention provides a higher degree of protection and shock absorbance from physical impacts. Moreover, the textile is durable and can be repeatedly used and washed.

Although, certain materials and manufacturing processes are disclosed herein, other comparable or suitable methods may be employed, as known in the art, to carry out the invention. While there have been described herein what are considered to be preferred and exemplary embodiments of the present invention, other modifications of the invention shall be apparent to those skilled in the art from the teachings herein. It is therefore desired to be secured, in the appended claims all such modifications as fall within the spirit and scope of the invention.

What is claimed is:

1. A composite textile comprising:
an outer layer of elastane;
an intermediate layer of open-cell foam; and
an inner layer of micro-suede or brushed elastane material.

2. The composite textile of claim 1 wherein the outer layer has a sun protective factor that protects a wearer of the textile from harmful effects from the sun.

3. The composite textile of claim 1 wherein the intermediate layer is a compressed ¼-inch polyurethane-ester open-cell foam.

4. The composite textile of claim 1 having a plurality of perforations configured to allow air exchange through the textile.

5. The textile of claim 1, wherein the outer layer is imaged with a three-dimensional pattern using an image-transfer device.

6. The composite textile of claim 1 that is made by the following steps:
flame bonding the outer, intermediate, and inner layers;
thermoforming said layers together; and
laser cutting to define and seal the edges of the layers to form the composite textile.

7. The method of claim 6 further comprising the step of embossing the outer layer of the textile after thermoforming.

8. The method of claim 6 wherein the thermoforming is performed by compression plates that are attached to a heated press.

9. The method of claim 6 wherein the thermoforming comprises a compression of the layers for approximately 60 seconds of hold time at 100 pounds of pressure.

10. The method of claim 6 wherein the thermoforming is performed at a temperature in the range of 380 to 420 degrees.

11. A textile article for protecting a wearer from sun and other outdoor elements comprising a nonwoven laminate comprised of
an outer layer of elastane;
an intermediate layer of open-cell foam; and
an inner layer of micro-suede or brushed elastane material.
